(19) United States
(12) Patent Application Publication
(10) Pub. No.: US 2026/0266591 A1
(43) Pub. Date: Sep. 10, 2026

(54) MEASURING SYSTEM FOR MEASURING A STATE OF WEAR OF A CONTACT ELEMENT

(71) Applicant: SCHUNK CARBON TECHNOLOGY GMBH, Bad Goisern (AT)

(72) Inventors: Tobias Maier, Berlin (DE); Robert Aigner, Bad Ischl (AT); Dominik Pascal Arnold, Heltersberg (DE); Michael Rastel, Bad Goisern (AT); Bernd Kuenstl, Bad Goisern (AT)

(21) Appl. No.: 18/871,764

(22) PCT Filed: Jun. 10, 2022
(86) PCT No.: PCT/EP2022/065846

§ 371 Date: Dec. 4, 2024

(51) Int. Cl. G01B 11/06; B60L 5/20

(52) U.S. Cl. CPC G01B 11/0608; B60L 5/20

(57) ABSTRACT

The invention relates to a measuring system (1) and a method for measuring a wear condition of a contact element (32) of a contact strip (3) for a catenary-bound power supply of vehicles with a sensor device (4), the contact strip (3) having a contact strip carrier (31) and the contact element (32) held on the contact strip carrier, and at least two drill holes (5, 6, 7, 8) being introduced in the contact strip (3), the drill holes (5, 6, 7, 8) passing through the contact strip carrier (31) and forming at least one blind hole (51, 61, 71) in the contact element (32), the sensor device (4) of the measuring device (1) being detachably fastened outside of the contact strip (3) and below the contact strip carrier (31), an optical radiation being able to be registered by means of a photodetector (52, 62, 72) of the sensor device (4), and at least one drill hole (5, 6, 7) of the at least two drill holes (5, 6, 7, 8) forming a light channel upon reaching a certain wear condition of the contact element (32), the optical radiation striking the photodetector (52, 62, 72) via the light channel, and the measuring system (1) comprising a processing device, the wear condition of the contact element (32) being able to be determined from the registered optical radiation by means of the processing device.

The invention relates to a measuring system and a method for measuring a wear condition of a contact element of a contact strip for a catenary-bound power supply of vehicles, the contact strip having a contact strip carrier and a contact element held in the contact strip carrier, and at least two drill holes being made in the contact strip, which pass through the contact strip carrier and form at least one blind bore in the contact element.

Contact strips made of carbon material are regularly used for the power supply of both rail-bound and non-rail-bound vehicles via a catenary. Such contact strips are always subject to wear due to abrasion of the material, usually carbon material. When using such contact strips, for example on locomotives of trains, it is necessary to replace them before they reach their final wear limit in order to avoid dangerous operating conditions, defects or breakdowns. While an emergency shutdown function, which causes the contact strip to be lowered when a final wear level is reached or even before if the contact strip is damaged, for example broken, is regularly integrated into contact strips, it no longer being possible to continue power supply and therefore further operation of the vehicle using this contact strip once such an emergency shutdown has been formed. To avoid such situations, contact strips are regularly inspected regarding their wear degree. These inspections are carried out regularly by personnel and are relatively time-consuming to perform, as the contact strips are mounted on the roof of a vehicle, such as a locomotive, and special safety precautions must be observed due to the high voltage applied to the catenary. Such inspections are therefore carried out at certain intervals in railroad depots. To avoid these costly inspections, partially automated wear monitoring systems are known which can signal when a wear limit has been reached. For example, WO 2014/173798 A2 describes a contact strip having a wear indication marking which can be detected using an infrared camera. During a passage of the camera positioned on a track, the contact strip can be detected by the camera and the wear indication marking can be recognized by image processing. Depending on the appearance of the wear indication marking, conclusions can now be drawn regarding the wear degree of the contact strip. The disadvantage here is that permanent monitoring of the wear condition of the contact strip is not possible and that considerable technical effort is required to install such monitoring systems along a rail network. For this reason, wear detection systems which can be integrated in the contact strip are known, as they do not require the complex installation of monitoring equipment along the rail network. Electrical contacts on the contact element or switches which can signal when a wear limit has been reached are known here. Solutions are also known in which a compressed air line is installed inside the contact strip to monitor the wear condition and a wear condition is detected due to a drop in compressed air in the line. However, the installation of such compressed air lines and the provision of compressed air is both technically and economically complex. It is also known to dispose sensors in the contact element of the contact strip in order to detect the wear of the contact strip. However, this also requires relatively complicated technological processes in order to integrate the sensors in the contact elements and, in particular, to wire the sensors. Another disadvantage of the previously known systems is that damage to the sensor technology due to progressing wear cannot be precluded and the sensor technology is not suitable for chronologically consecutive monitoring of several contact strips in the sense of reuse of the sensor technology due to their complex arrangement in the contact strip.

The object of the invention at hand is therefore to propose a measuring system and a method for measuring a wear condition of a contact strip, which can determine a wear condition in an automated manner and with little effort. In addition, the measuring system is to be installed with little effort and independently of the contact strip, meaning the measuring system can be reused.

This object is attained by a measuring system having the features of claim 1, a method having the features of claim 11, a contact strip having the features of claim 16, a current collector having the features of claim 17, and a vehicle having the features of claim 18.

The measuring system according to the invention for measuring a wear condition of a contact element of a contact strip for a catenary-bound power supply of vehicles with a sensor device, the contact strip having a contact strip carrier and the contact element held on the contact strip carrier, and at least two drill holes being introduced in the contact strip, the drill holes passing through the contact strip carrier and forming at least one blind hole in the contact element, having a sensor device which is detachably fastened outside of the contact strip and below the contact strip carrier, an optical radiation being able to be registered by means of a photodetector of the sensor device, and at least one drill hole of the at least two drill holes forming a light channel upon reaching a certain wear condition of the contact element, the optical radiation striking the photodetector via the light channel, and the measuring system comprising a processing device, the wear condition of the contact element being able to be determined from the registered optical radiation by means of the processing device. Preferably, the wear condition of the contact element can be determined based on the height of the contact element, the height decreasing with increasing service life due to abrasion on the catenary.

The contact strip comprises a contact element which is usually made of carbon material and can abut against a catenary and thereby establish an electrical connection with it. This contact element is held by a contact strip carrier, which in turn is mounted on a so-called pantograph or swing arm. This pantograph and/or swing arm forms a positioning device for the contact strip and thus, together with the contact strip, a so-called current collector. This in turn is mounted on the roof of a vehicle in order to contact the catenary located above the vehicle.

According to the invention, a measuring system is provided for being disposed on a contact strip, which comprises a sensor device. This sensor device is detachably mounted outside the contact strip and below the contact strip carrier, preferably in the vicinity of the contact strip. In the context of the invention, detachably mounted means that the sensor device can be removed non-destructively and can therefore be replaced and/or reused. For instance, the sensor device can be disposed on a first contact strip carrier for monitoring the first contact element held on this contact strip carrier and, after reaching the wear limit of the first contact element of the first contact strip carrier, can be removed and disposed on a further contact strip carrier in order to monitor the further contact element of the further contact strip carrier. It is conceivable that the sensor device is detachably mounted to the contact strip, in particular to the contact strip carrier, or to a positioning device holding the contact strip adjacent to the contact strip. Preferably, the sensor device, in particular a casing of the sensor device, is detachably mounted by means of screws. The detachable mounting of the sensor device outside the contact strip means that the sensor device is formed independently of the contact strip. The measuring system, in particular the sensor device, can then be physically spaced apart from and/or be integrated functionally independently of the contact strip. Advantageously, this also means that a connection, in particular an electrically conductive connection, between the measuring system and the rail vehicle is not strictly necessary. Instead, the measuring system can be operated without a connection to the low-voltage network of the rail vehicle, for example by means of a battery, an accumulator or an energy harvester. The measuring system can thus be used independently of the type of rail vehicle and without special certification from a rail vehicle manufacturer. Nevertheless, it can optionally be provided that the measuring system is connected to the rail vehicle, for example to a driving position of the rail vehicle, in order to signal measured values to a vehicle driver. It is known that a measured value is the value of a measured variable supplied by the sensor device. In the context of the invention, measured values can, for example, be related to a height H of the contact strip, a wear degree of the contact strip, a detected light incidence and/or a temperature. For example, wear of the contact element can be signaled in a driving position, or further measured values can be provided in the driving position. Preferably, however, the sensor device of the measuring system can be used independently of the rail vehicle.

By means of the sensor device, which has at least one photodetector, optical radiation can be detected which, upon reaching a certain wear condition of the contact element, strikes the photodetector through a light channel. Preferably, the optical radiation detected by the photodetector is a daylight-induced light incidence in one of the drill holes. This drill hole is exposed due to the abrasion of the contact element, which is caused by the friction between the contact element and the catenary during operation of the contact strip, meaning when a certain wear condition is reached, a blind bore is no longer formed in the contact element, but a light channel is formed by exposing the drill hole, which leads from the upper side of the contact element to the photodetector of the sensor device. The photodetector is preferably configured in the manner of a photodiode. According to the invention, at least two drill holes are made in the contact strip, of which at least one drill hole forms a blind bore in the contact element in order to be able to form a light channel by exposing this drill hole, depending on the wear condition of the contact element. The other drill hole, which preferably only passes through the contact strip carrier and ends at the underside of the contact element, can be used to detect another measured value, such as the temperature. This makes it advantageously possible to determine a correlation between wear on the contact element and another measured value, such as temperature, and to include this in maintenance planning, for example.

Furthermore, the measuring system comprises a processing device by means of which the wear condition of the contact element can be determined from the detected optical radiation, preferably a light incidence. It is essential that the processing device can correlate the respective measured values of the sensors to each other. This makes it possible to obtain further information about the operating status of the contact element, the current collector and/or the catenary.

In the context of the invention, the term “drill hole” refers to any recess which extends through the contact strip carrier and can preferably be introduced in the contact strip using a machining process. For example, a drill hole can be conical or cylindrical in shape, with cylindrical drill holes preferably being introduced in the contact strip.

The terms “below”, “above”, “underside” and “upper side” always refer to the mounted state of the contact strip on the vehicle, so that, for example, the upper side of the contact element is the side which comes into contact with the catenary when the contact strip is in operation, and the underside of the contact element is the side of the contact element which is disposed on the contact strip carrier. Accordingly, the upper side of the contact strip carrier is the side on which the contact element rests, and the underside of the contact strip carrier is the side opposite the upper side and thus facing away from the contact element. Accordingly, the upper side of the sensor device and/or the upper side of a casing of the sensor device faces the contact strip carrier and the underside opposite the upper side faces away from the contact strip carrier.

It is known to the person skilled in the art that the length L of a contact strip is regularly greater than its width B. The sensor device is preferably disposed at the center of a length L of the contact strip. The drill holes are preferably introduced at the center of a width B of the contact strip. This offers the advantage that the wear can be detected at the location where the greatest wear is expected. Furthermore, the terms width B and length L of the contact strip also refer to the mounted state of the contact strip, meaning the length L of the contact strip extends transversely and the width B extends along the direction of travel of the rail vehicle on which the contact strip is mounted.

The fundamental idea of the invention is that a sensor device can be used independently of the contact strip to detect the wear condition of a contact element of a contact strip and, due to the arrangement of the sensor device of the measuring system outside the contact strip, the measuring system can be reused. As only drill holes need to be made in the contact strip, but no further wiring and/or insertion of sensors into the contact strip is required, the sensor device can be reused by simply dismantling the sensor device of the measuring system and mounting it on another contact strip. The structure and arrangement of the measuring system according to the invention also prevent destruction of the sensor technology or cost-intensive cable elements, as contact of the catenary with the sensor system and thus abrasion by the catenary leading to destruction of the sensor technology are reliably prevented, particularly in the event of excessive wear of the contact element. In addition, the measuring system according to the invention advantageously makes it possible to detect at least one other measured value in addition to the wear condition and to correlate it to the wear condition. Furthermore, both the structure and the arrangement of the measuring system can be realized in a particularly simple manner and the operation of the measuring system can be carried out in a particularly energy-efficient manner, since neither media, such as compressed air, nor connection lines within the contact strip carrier, for example for power supply, have to be provided. Instead, when a certain wear condition is reached, the optical radiation falls directly into the light channels and from there onto the sensor device without the need for further components in the contact element.

Advantageous embodiments of the invention are the subject matter of the dependent claims. In addition, all combinations of at least two features disclosed in the description, the claims or the figures fall within the scope of the invention. It is understood that the explanations made with respect to the measuring system refer in an equivalent manner to the contact strip according to the invention, the current collector according to the invention and the vehicle according to the invention, without being mentioned separately for the latter. Likewise, all features and embodiments disclosed with respect to the measuring system refer in an equivalent, even if not in a verbatim, manner to the method according to the invention.

The sensor device can have a temperature sensor, which is disposed such in the area of a drill-hole opening of a drill hole of the at least two drill holes that the temperature of the contact element is able to be registered by means of the temperature sensor. Since the temperature of the contact strip, in particular of the contact element, has a strong influence on the wear of the contact strip, it has proven to be advantageous to determine the wear condition as a function of the temperature in order to be able to react in good time, for example by replacing the contact element, in the event of significant temperature changes or temperature stresses on the contact element. Preferably, the temperature sensor is disposed below a drill-hole opening. The temperature sensor is also preferably designed as an infrared sensor so that contactless measurement of the temperature of the contact element is possible. The drill hole, at the drill-hole opening of which the infrared sensor is disposed, forms an infrared beam channel which extends through the carrier element at least as far as the underside of the contact element. The non-contact measurement by means of the infrared sensor makes it possible to position the sensor in the area of the drill-hole opening independently of the contact strip, in particular without a temperature sensor having to protrude into the contact strip for temperature measurement and being damaged by progressive abrasion. This, in turn, advantageously leads to the continued use of the sensor device comprising a temperature sensor, as it can be disposed on the contact strip independently of the contact strip and destruction of the temperature sensor can be precluded both during operation of the contact strip and during disassembly.

It has proven to be advantageous that the drill hole, at the drill-hole opening of which the temperature sensor is disposed, extends through the contact strip carrier to the underside of the contact element. This makes it easy to measure the temperature and detect the optical radiation from below the contact strip at the same time.

The sensor device of the measuring system has a casing, which has an opening covering the at least two drill holes at the upper side of the casing abutting against the contact strip carrier. The casing serves on the one hand to protect the sensor device and on the other hand to facilitate the assembly and disassembly of the sensor device on the contact strip carrier. Due to the opening covering the at least two drill holes on the upper side abutting against the contact strip carrier, the casing of the sensor device can preferably be designed and disposed in such a manner that the underside of the contact strip carrier at least partially forms the upper side of the casing and the upper side of the casing is closed by the underside of the contact strip carrier. Alternatively or additionally, the casing can have several openings which are disposed on the upper side of the casing complementarily to the at least two drill holes. The sensor device is then disposed in such a manner on the contact strip carrier that the openings of the casing and the drill holes in the contact strip at least partially overlap. In addition to a simple mounting of the sensor device on the contact strip, it can thus be ensured that light incidence on the photodetector takes place through the contact strip and the openings in the casing and/or that another channel, for example for temperature measurement, leads through the contact strip carrier and the upper side of the casing. The casing is preferably made of plastic or pure metallic material.

Several drill holes of differing depth, which form a light channel upon reaching a certain wear condition of the contact element, can be introduced in the contact strip. In other words, this means that the contact strip has several blind bores of differing depth which extend through the contact strip carrier and into the contact element. The processing device can therefore determine the degree of wear of the contact strip. If further drill holes are exposed with increasing abrasion, whereby further light channels are formed and thus an increased light incidence is registered by one or more photodetectors, a conclusion can be drawn regarding the degree of wear of the contact element. In this manner, it is not only possible to determine whether the contact element is new or completely worn, but also to what extent the contact element has been consumed. If a contact strip is worn, a shape, in particular a height of the contact strip, can be changed, the change in height of the contact strip preferably being used as a reference for the degree of wear. The drill holes, which preferably lead vertically from the underside of the contact strip carrier into the contact element, can determine the remaining height of the contact element depending on the wear condition. This means that the more drill holes are exposed, the lower the height of the contact element and the higher the degree of wear.

It has proven to be advantageous that a photodetector is provided per drill hole, which each form a light channel upon reaching a certain wear condition of the contact element. This has the advantage of increasing the accuracy of the registration, as each light channel is assigned to a photodetector and therefore another photodetector emits a signal when another light channel is formed by the opening of another drill hole due to abrasion. This means that incorrect measurements due to fluctuations in light incidence, for example, can be precluded.

At least one drill hole can be filled with a temperature-resistant and transparent filling element, which is preferably made of plastic, for example polyester resin, silicone resin or Teflon (PTFE), or of glass, for example acrylic glass. Preferably, the filling element is temperature-resistant up to at least 200° C., more preferably up to at least 300° C. Even more preferably, the drill holes, which are formed through the contact strip carrier and form a blind bore in the contact element, are filled with the filling element. Most preferably, the drill hole passing through the contact strip carrier and forming the blind bore with the shallowest depth in the contact element is filled with the filling element, while the other blind bores in the contact element are unfilled. It is conceivable that a filling element is connected to a photodetector via a sealing ring, preferably a silicone sealing ring, in order to ensure simple installation, reliable radiation conduction and high resistance, particularly to vibrations during driving.

The filling element can be formed complementarily to the drill hole and can be insertable in the drill hole. This advantageously enables the filling element to be inserted independently of the contact strip and, in particular, independently of the production of the contact strip, so that the filling elements can also be inserted retrospectively. Because the filling element can be inserted in the contact strip, it can also be inserted retrospectively in an existing contact strip by drilling and insertion without having to observe any restrictions during the production of the contact strip.

According to an advantageous embodiment, three drill holes of differing depth are introduced in the contact strip, pass through the contact strip carrier and form three blind bores in the contact element, the three drill holes forming a light channel, through which the optical radiation strikes the photodetector, upon reaching a certain wear condition of the contact element. This allows the wear degree to be determined economically and in accordance with requirements by three different wear degrees being able to be determined by the three drill holes of differing depth.

It has also proven to be advantageous that when three drill holes of differing depths are introduced in the contact strip, each forming a blind bore in the contact element, two of the three drill holes are unfilled and the drill hole which engages with the shallowest depth in the contact element is filled with a temperature-resistant transparent filling element. The filling element inserted in the drill hole engaging with the shallowest depth in the contact element is preferably made of plastic, for example polyester resin, silicone resin or Teflon (PTFE), or of glass, for example acrylic glass. It is also preferable that the filling element can be inserted in the drill hole.

In the method according to the invention for measuring a wear condition of a contact element of a contact strip for a catenary-bound power supply of vehicles with a measuring system, the contact strip having a contact strip carrier and a contact element held on the contact strip carrier, and at least two drill holes being introduced in the contact strip, the drill holes passing through the contact strip carrier and forming at least one blind hole in the contact element, an incidence of optical radiation in the sensor device is registered by means of a photodetector of the sensor device. The incidence of the optical radiation is detected by forming a light channel for the optical radiation, through which the optical radiation is directed onto the photodetector, through at least one drill hole of the at least two drill holes upon reaching a certain wear condition of the contact element. By means of a processing device of the measuring system, the wear condition of the contact element can be determined on the basis of the incident optical radiation, in particular on the basis of the signal generated by the photodetector due to the light incidence. The at least one further drill hole, which passes through the contact strip carrier but does not form a blind bore in the contact element, can be used to register a further characteristic value, for example the temperature, of the contact element and/or the contact strip. Preferably, the sensor device of the measuring system is disposed on the contact strip and/or adjacent to the contact strip on a positioning device holding the contact strip and outside the contact strip, so that the sensor device can be detached from the contact strip in a non-destructive manner and, for example after replacing the contact strip, can be reused on a new contact strip. With regard to the advantages of the method for measuring the wear condition of a contact element, reference is made to the more detailed description of the measuring system according to the invention.

According to one embodiment of the method, the temperature of the contact element is registered by means of a temperature sensor of the sensor device. In order to enable the temperature of the contact element to be registered as independently as possible of the contact strip, the temperature is preferably determined by means of an infrared sensor, which registers the temperature without contact using the infrared radiation reflected onto the infrared sensor by a drill hole in the contact strip carrier.

The processing device can register and store the measured values from the sensor device in regular temporal intervals and/or following changes. Alternatively, the processing device can continuously register and store the measured values of the sensor device. Accordingly, it can be provided that the measured values are only registered and/or stored when the values change in order to keep the amount of data low. Alternatively, it is possible to provide continuous recording and storage. By storing the measured values, it is possible to process the measured values even after the measured values have been registered at a distance in terms of location and/or time. For instance, measured values can then be registered while the rail vehicle is in motion, further characteristic values being able to only be determined during maintenance of the rail vehicle in a depot. For instance, the temperature measurement can be correlated with the wear measurement and evaluated after a journey.

A wear degree of the contact strip, in particular of the contact element, can be determined from the measured values from the sensor device by means of the processing device. If a blind bore is exposed in the contact element with increasing abrasion and a light channel is thus formed, the signal transmitted by the photodetector changes or a signal from another photodetector is added so that a conclusion can be drawn from this change regarding the degree of wear of the contact strip. If several blind bores of differing depth are introduced in the contact element, the extent to which the contact element is worn can be determined by the processing device depending on the depth of the exposed blind bores. Preferably, the processing device determines the wear degree of the contact strip using the height of the contact element remaining due to wear based on the blind bores exposed by the abrasion.

The measured values of the sensor device can transmitted from the sensor device to the processing device by means of a transmission device, the processing device being able to be spaced apart from the sensor device or being able to be integrated in the casing of the sensor device. If the processing device is integrated in the casing of the sensor device, the data connection can be designed in a simple manner as a wired connection. Alternatively, it is also possible to dispose the processing device so as to be physically spaced apart from the sensor device and to transmit the measured values of the sensor device preferably wirelessly, for example by means of a radio signal, from the sensor device to the processing device. In this case, the processing device can also be installed at a different location on the vehicle or far away from the rail vehicle, for example in a building. When transmitting the measured values, data can be exchanged, for example on the basis of a transmission protocol. The data connection can be established continuously, at regular intervals or event-based. Overall, this makes it possible to collect and evaluate the data recorded by the sensor device.

The contact strip according to the invention for a power supply for vehicles comprises a measuring system according to the invention disposed on the contact strip.

The current collector according to the invention for a catenary-bound power supply of vehicles comprises a positioning device and a contact strip according to the invention disposed thereon.

The vehicle according to the invention, in particular a rail vehicle or the like, has a current collector according to the invention.

The invention is explained in more detail below with reference to the accompanying drawings.

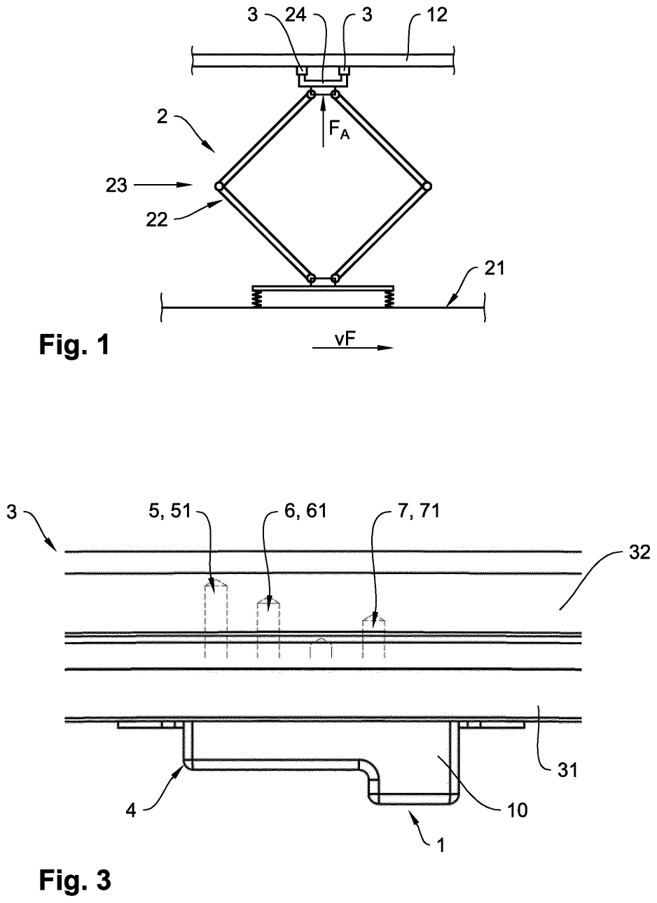

FIG. 1 shows a schematic time view of a pantograph.

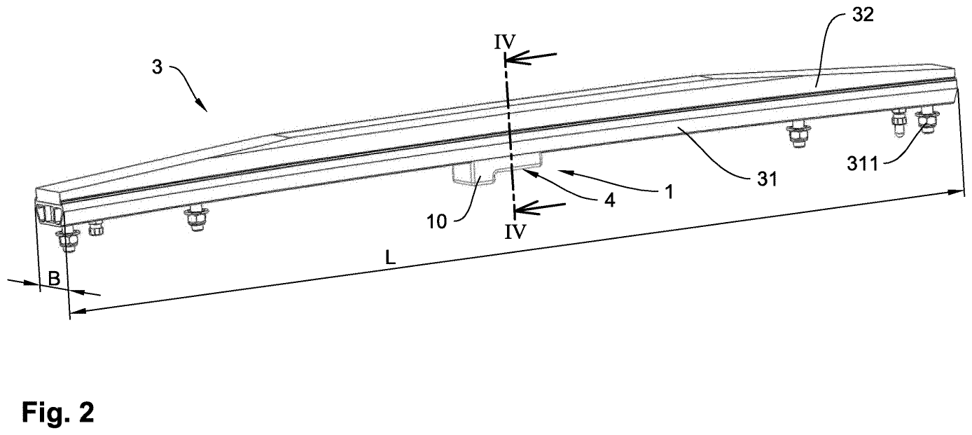

FIG. 2 shows an isometric view of a contact strip having a measuring system according to the invention.

FIG. 3 shows a section of the contact strip according to FIG. 2 having a measuring system according to the invention with transparent representation of the contact element.

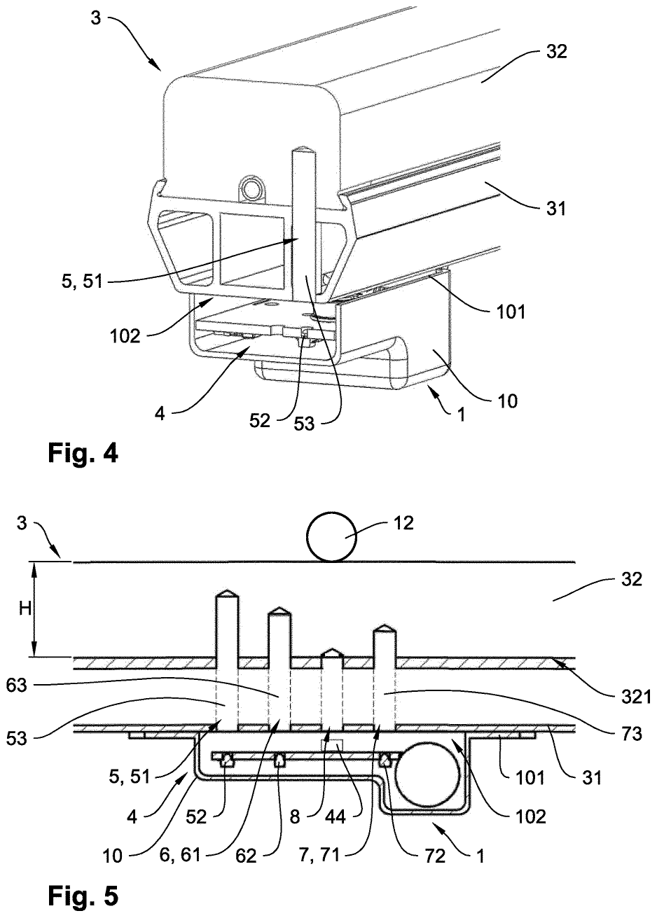

FIG. 4 shows a sectional view along a line IV-IV from FIG. 1.

FIG. 5 shows a sectional view along the longitudinal axis of the contact strip as shown in FIG. 2.

FIG. 1 shows a current collector 2 on a roof 21 of a rail vehicle (not shown) having a positioning device 23 in the form of a pantograph 22. On the pantograph 22, two contact strips 3 are disposed on a rocker 24 transverse to a catenary 12. The rail vehicle moves at a speed V_{F} relative to the catenary 12, the contact strips 3 being pressed against the catenary 12 transversely and/or orthogonally with a contact force F_{A}. The contact strip 3 is made of a carbon contact element 32 (not shown) and a contact strip carrier 31, the movement of the contact strip 3 on the catenary 12 as described here resulting in abrasion of the carbon material.

FIG. 2 shows a contact strip 3 according to the invention having the measuring system 1 according to the invention, whose casing 10, in which the sensor device 4 is located, is disposed centrally on the contact strip 3 in relation to the length L and the width B of the contact strip 3. The contact strip 3 is essentially formed from a contact element 32, which consists of carbon or graphite, and a contact strip carrier 31. The contact strip carrier 31 has a profile which regularly consists of a metallic material, such as steel or aluminum, on which the contact element 32 is mounted. On the profile, fastening bearings 311 are formed, which serve to connect the contact strip 3 to a rocker (not shown). The contact element 32 is disposed on the contact strip carrier 31 and thus essentially above the contact strip carrier 31. The sensor device 4, on the other hand, is disposed below the contact strip carrier 31. Due to the central arrangement of the casing 10 in relation to both the length L and the width B, the casing 10 has nearly no influence on the aerodynamics of the contact strip 3 and/or the current collector 2 (not shown) during driving operation, also due to the compact design of the casing 10.

FIG. 3 shows a section of the contact strip 3 which is shown in FIG. 2 and in which the contact element 32 is shown transparently so that the drill holes 5, 6, 7 are visible. The drill holes 5, 6, 7 have differing depths and, starting from the underside of the contact strip carrier 31, extend through the contact strip carrier 31 and end inside the contact element 32. As the contact element 32 as shown in FIG. 3 shows no wear, the three drill holes 5, 6, 7 each form a blind bore 51, 61, 71. As the contact element 32 wears, the blind bores 51, 61, 71 are opened one after the other and each forms a light channel, through which optical radiation reaches the sensor device 4. It can be seen from FIG. 3 that the drill hole 5 engaging deepest in the contact element 32 is exposed first due to wear, followed by the drill hole 6 and finally the drill hole 7. Thus, at least three degrees of wear of the contact element 32 can be determined by means of the contact strip 3 shown in FIG. 3 and the measuring system 1 disposed therein.

A combined view of FIGS. 4 and 5 shows the contact strip 3 according to the embodiment shown in FIG. 2 in various sectional views. The casing 10 of the measuring system 1, which protects the sensor device 4 from environmental influences, is attached to the underside of the contact strip carrier by its upper side 101. It can be seen that the casing 10 is disposed on the contact strip carrier 31 in such a manner that the underside of the contact strip carrier closes the upper side 101 of the casing 10 having an opening 102.

In the sectional view shown in FIG. 4, a drill hole 5 forming a blind bore 51 in the contact element 32 and passing through the contact strip carrier 31 is inserted into the contact strip 3. To protect the sensor device 4 from environmental influences and in particular from the dirt particles produced by the abrasion of the contact element 32, a transparent filling element 53, which is designed as a cylindrical rod, is inserted in the drill hole 5. As soon as the drill hole 5 is exposed due to the height reduction of the contact element 32 caused by the abrasion, light can fall through the transparent filling element 53 onto the photodetector 52 of the sensor device 4 through this rod element. The light incidence on the photodetector 52 causes a signal change and/or signal triggering of the photodetector 52, on the basis of which the processing device (not shown) of the measuring system 1 can determine a wear degree of the contact strip 3.

FIG. 5 shows a longitudinal section through a contact strip 3 according to the embodiment shown in FIG. 2. The longitudinal section shows that a total of four drill holes 5, 6, 7, 8 are introduced in the contact strip 3. Three drill holes 5, 6, 7 pass through the contact strip carrier 31 and form a blind bore 51, 61, 71 in the contact element 32. A photodetector 52, 62, 72 is disposed below each of the drill holes 5, 6, 7 and each one is assigned to a drill hole 5, 6, 7. This means that if the drill hole 5 and/or the blind bore 51 is exposed, light is incident through the transparent filling element 53 onto the photodetector 52, which outputs a signal to the processing device (not shown). If the height H of the contact element 32 is subsequently reduced further due to further wear, thus exposing the drill hole 6, the photodetector 62 assigned to the drill hole 6 emits a signal change or a signal due to the light incidence through the transparent filling element 63. The drill hole 7 is exposed last due to wear, the photodetector 72 outputting a signal as a result of the light incidence through the transparent filling element 73 on the photodetector 72. Since the drill holes 5, 6, 7 have differing depths, the drill holes 5, 6, 7 are exposed at different times depending on the wear-related reduction in the height H of the contact element 32. It is conceivable that when the two deepest drill holes 5, 6 are exposed, an informing or warning signal is output to the operator of the rail vehicle and when the drill hole 7 is subsequently exposed, the contact strip 3 is separated from the catenary 12 due to the high wear of the contact element 32. It can be seen that the upper side 101 of the casing 10 of the sensor device 4 is disposed on the underside of the contact strip carrier 31. An opening 102 in the upper side 101 of the casing 10 is disposed in such a manner that, on the one hand, the contact strip carrier 31 closes the upper side 101 of the casing 10 and, at the same time, light incidence through the drill holes 5, 6, 7 and incidence of further radiation through the drill hole 8 onto the sensor device 4 is made possible. In contrast to the drill holes 5, 6, 7, the drill hole 8 only passes through the contact strip carrier 31 and ends at the underside 321 of the contact element 32. Due to the infrared radiation reflected by the contact element 32, the temperature sensor 44 designed as an infrared sensor can detect the temperature of the contact element 32. This allows the height H of the contact element 32, the wear degree of the contact element 32 and the temperature of the contact element 32 to be correlated with each other in the processing device and thus the wear behavior can be analyzed using several parameters.

1. A measuring system (1) for measuring a wear condition of a contact element (32) of a contact strip (3) for a catenary-bound power supply of vehicles with a sensor device (4), the contact strip (3) having a contact strip carrier (31) and the contact element (32) held on the contact strip carrier, and at least two drill holes (5, 6, 7, 8) being introduced in the contact strip (3), the drill holes (5, 6, 7, 8) passing through the contact strip carrier (31) and forming at least one blind hole (51, 61, 71) in the contact element (32),
characterized in that
the sensor device (4) of the measuring system (1) is detachably fastened outside of the contact strip (3) and below the contact strip carrier (31), an optical radiation being able to be registered by means of a photodetector (52, 62, 72) of the sensor device (4), and at least one drill hole (5, 6, 7) of the at least two drill holes (5, 6, 7, 8) forming a light channel upon reaching a certain wear condition of the contact element (32), the optical radiation striking the photodetector (52, 62, 72) via the light channel, and the measuring system (1) comprising a processing device, the wear condition of the contact element (32) being able to be determined from the registered optical radiation by means of the processing device.

2. The measuring system according to claim 1,
characterized in that
the sensor device (4) has a temperature sensor (44), preferably an infrared sensor, the temperature sensor (44) being disposed such in the area of a drill-hole opening of a drill hole (8) of the at least two drill holes (5, 6, 7, 8) that the temperature of the contact element (32) is able to be registered by means of the temperature sensor (44).

3. The measuring system according to claim 1, characterized in that the drill hole (8), at whose drill-hole opening the temperature sensor (44) is disposed, extends through the contact strip carrier (31) to the underside (321) of the contact element (32).

4. The measuring system according to claim 1,
characterized in that
the sensor device (4) of the measuring system (1) has a casing (10), which has an opening (102) covering the at least two drill holes (5, 6, 7, 8) at the upper side (101) abutting against the contact strip carrier (31) and/or has several openings which are disposed at the upper side (101) of the casing (10) complementarily to the at least two drill holes (5, 6, 7, 8) in the contact strip (3).

5. The measuring system according to claim 1,
characterized in that
several drill holes (5, 6, 7) of differing depth form a light channel upon reaching a certain wear condition of the contact element (32).

6. The measuring system according to claim 5,
characterized in that
a photodetector (52, 62, 72) is provided per drill hole (5, 6, 7), which each form a light channel upon reaching a certain wear condition of the contact element (32).

7. The measuring system according to claim 1,
characterized in that
at least one drill hole (5, 6, 7, 8) is filled with a temperature-resistant and transparent filling element (53, 63, 73).

8. The measuring system according to claim 7, characterized in that the filling element (53, 63, 73) is formed complementarily to the drill hole (5, 6, 7, 8) and is insertable in the drill hole (5, 6, 7).

9. The measuring system according to claim 1,
characterized in that
three drill holes (5, 6, 7) of differing depth are introduced in the contact strip (3), pass through the contact strip carrier (31) and form three blind bores (51, 61, 71) in the contact element (32), the three drill holes (5, 6, 7) forming a light channel, through which the optical radiation strikes the photodetector (52, 62, 72), upon reaching a certain wear condition of the contact element (32).

10. The measuring system according to claim 1,
characterized in that
at least two drill holes (5, 6) are unfilled and the drill hole engaging in the contact element (32) with the least depth is filled with a temperature-resistant and transparent filling element (73).

11. A method for measuring a wear condition of a contact element (32) of a contact strip (3) for a catenary-bound power supply of vehicles with a measuring system (1), the contact strip (3) having a contact strip carrier (31) and the contact element (32) held on the contact strip carrier (31), and at least two drill holes (5, 6, 7, 8) being introduced in the contact strip (3), the drill holes (5, 6, 7, 8) passing through the contact strip carrier (31) and forming at least one blind hole (51, 61, 71) in the contact element (32),
characterized in that
an incidence of optical radiation in the sensor device (4) is registered by means of a photodetector (52, 62, 72) of the sensor device (4), a light channel, through which the optical radiation is conducted to the photodetector (52, 62, 72), being formed by at least one drill hole (5, 6, 7) of the at least two drill holes (5, 6, 7, 8) upon reaching a certain wear condition of the contact element (32) and the wear condition of the contact element (32) being determined on the basis of the incident optical radiation by means of a processing device of the measuring system (1).

12. The method according to claim 10,
characterized in that
the temperature of the contact element (31) is registered by means of a temperature sensor (44) of the sensor device (4), preferably by means of an infrared sensor.

13. The method according to claim 10,
characterized in that
the processing device continuously registers and stores the measured values from the sensor device (4) in regular temporal intervals and/or following changes.

14. The method according to claim 10,
characterized in that
a wear degree of the contact strip (3), in particular of the contact element (329), is determined from the measured values from the sensor device (4) by means of the processing device.

15. The method according to claim 10,
characterized in that
the measured values of the sensor device (4) are transmitted, preferably wireless, from the sensor device (4) to the processing device by means of a transmission device, the processing device being physically spaced apart from the sensor device (4) or being integrated in the casing (10) of the sensor device (4).

16. A contact strip (3) having a measuring system (1) disposed thereon according to any one of the claim 1.

17. A current collector for a catenary-bound power supply of vehicles comprising a positioning device having a contact strip (3) according to claim 16 disposed thereon.

18. A vehicle, in particular a rail vehicle, having a current collector according to claim 17.
